(19) United States
(12) Patent Application Publication
(10) Pub. No.: US 2019/0114258 A1
(43) Pub. Date: Apr. 18, 2019

(54) STORAGE CONTROL APPARATUS AND METHOD OF CONTROLLING GARBAGE COLLECTION

(71) Applicant: FUJITSU LIMITED, Kawasaki-shi (JP)

(72) Inventors: Yukari Tsuchiyama, Kawasaki (JP); Chikashi Maeda, Kawasaki (JP); Guangyu ZHOU, Kawasaki (JP); Kazuhiko IKEUCHI, Kawasaki (JP)

(73) Assignee: FUJITSU LIMITED, Kawasaki-shi (JP)

(21) Appl. No.: 16/157,150

(22) Filed: Oct. 11, 2018

(30) Foreign Application Priority Data
Oct. 16, 2017 (JP) 2017-200066

(51) Int. Cl. G06F 12/02; G06F 3/06

(52) U.S. Cl. CPC G06F 12/0253; G06F 3/0604; G06F 3/0608; G06F 2212/7205; G06F 3/0679; G06F 2212/1044; G06F 3/0659

(57) ABSTRACT

A storage control apparatus that controls a plurality of storage devices, each of which includes a plurality of storage groups, the storage control apparatus includes a memory, a processor coupled to the memory and the processor configured to detect a first storage device from the plurality of storage devices, the first storage device having an area on which garbage collection is to be executed, identify a first storage group from the plurality of storage groups, the first storage group including the first storage device, prohibit write access to the plurality of storage devices included in the identified first storage group, and instruct the first storage device to execute the garbage collection.

### CROSS-REFERENCE TO RELATED APPLICATION

This application is based upon and claims the benefit of priority of the prior Japanese Patent Application No. 2017-200066, filed on Oct. 16, 2017, the entire contents of which are incorporated herein by reference.

### FIELD

The embodiments discussed herein are related to a storage control apparatus and a method of controlling garbage collection.

### BACKGROUND

In recent years, storage systems, which adopt a solid state drive (SSD) having higher read and write performance than a hard disk drive (HDD), have been widely used. The SSD includes a NAND flash memory as a memory device. The NAND flash memory is a type of non-volatile memory device, and has characteristics that data may not be overwritten.

Writing to a NAND flash memory is performed page by page, and data is erased block by block where each block includes multiple pages. The page size of a NAND flash memory depends on its design, and is set to 4 KB or 8 KB, for instance.

As mentioned above, writing to an SSD is not possible unless data on the SSD is erased, thus when data is rewritten, write data is written to a free page, and a page including old data is set to an invalid page.

When there are not enough free pages, some invalid pages have to be erased to create free pages. Since data is erased block by block as mentioned above, when an invalid page is erased, the data in valid pages in the same block is read and saved in a cache memory, and after the block is erased, processing occurs, in which the data in the valid pages is written back.

Due to the above-described characteristics, when free areas are secured block by block, the efficiency of processing is increased. Thus, in the SSD, processing (garbage collection (GC)) to aggregate valid data as much as possible is performed.

In a situation where there are enough spare blocks on which erasure processing has been performed, writing is performed using a spare block, and a block is erased by back-end processing, thereby making it possible to reduce the effect of generation of spare blocks on write performance. However, when the spare blocks are exhausted, at the time of writing, processing to save the data in the valid pages and create free blocks has to be performed, which causes response delay at the time of writing.

It is to be noted that exhaustion of the spare blocks is likely to occur in a situation where random access to small-size data occurs frequently, for instance. The above-mentioned GC is processing autonomously performed by the SSD. However, recently, a technique called storage intelligence (SI) has been proposed, which allows execution timing of internal processing such as GC to be controlled from a host computer or a redundant arrays of inexpensive disks (RAID) controller. In the SI, commands to specify an execution command for GC, an operating time of GC, and the volume of spare blocks to be created are defined.

Regarding the control of GC in the SSD, a method to controlling GC SSD by SSD has been proposed. In the method, the unit of volume, to which write access is inhibited during execution of GC, is the entire single SSD.

Related techniques are disclosed in, for example, Japanese Laid-open Patent Publication Nos. 2016-192025 and 2016-162397.

### SUMMARY

According to an aspect of the embodiments, a storage control apparatus that controls a plurality of storage devices, each of which includes a plurality of storage groups, the storage control apparatus includes a memory, a processor coupled to the memory and the processor configured to detect a first storage device from the plurality of storage devices, the first storage device having an area on which garbage collection is to be executed, identify a first storage group from the plurality of storage groups, the first storage group including the first storage device, prohibit write access to the plurality of storage devices included in the identified first storage group, and instruct the first storage device to execute the garbage collection.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a storage system according to first embodiment;

FIG. 2 is a diagram illustrating an example of a storage system according to a second embodiment;

FIG. 3 is a diagram illustrating an example of a function of a storage control apparatus;

FIG. 4 is a table illustrating an example of a GC target table;

FIG. 5 is a table illustrating an example of a save destination information table;

FIG. 6 is a table illustrating an example of a RAID group management table;

FIG. 7 is a flowchart illustrating the flow of processing related to detection of a GC target RAID group;

FIG. 8 is a flowchart illustrating the flow of processing related to setting a predetermined value;

FIG. 9 is a first flowchart illustrating the flow of processing related to execution of GC;

FIG. 10 is a second flowchart illustrating the flow of processing related to execution of GC;

FIG. 11 is a third flowchart illustrating the flow of processing related to execution of GC;

FIG. 12 is a first flowchart illustrating the flow of processing according to a request for write access;

FIG. 13 is a second flowchart illustrating the flow of processing according to a request for write access;

FIG. 14 is a first flowchart illustrating the flow of processing according to a request for read access;

FIG. 15 is a second flowchart illustrating the flow of processing according to a request for read access; and

FIG. 16 is a flowchart illustrating the flow of processing to write back.

### DESCRIPTION OF EMBODIMENTS

A RAID group is set to a storage system. For instance, a RAID group in a redundant configuration of three RAIDs such as RAIDs 1, 5, and 6 is set to a storage system. It is to be noted that RAID 1 is called mirroring and RAIDs 5, 6 are called parity dispersion recording block by block. In a RAID group having a redundant configuration, access patterns to multiple recording media forming the RAID group tend to resemble each other.

When a RAID group in a redundant configuration is formed with SSDs, access patterns to multiple SSDs in the same RAID group resemble each other. Therefore, when one SSD is in a state where spare blocks are exhausted, it is probable that other SSDs are also in the same state.

In the above-described method proposed, that is, in the method of controlling GC SSD by SSD regarding the control of GC in the SSD, write access is inhibited SSD by SSD, thus even when multiple SSDs, in which the spare blocks are almost exhausted, are present in the same RAID group, write access is inhibited in only one SSD. Thus, there is a risk that write access is made to another SSD in which the spare blocks are exhausted or the spare blocks are almost exhausted. When write access is made to another SSD, the above-mentioned erasure processing occurs, and response is delayed.

Hereinafter an embodiment of a technique to reduce risk of delay in response will be described with reference to the accompanying drawings. It is to be noted that in the present description and the drawings, components having substantially the same function are labeled with the same symbol, and a redundant description may be omitted.

### First Embodiment

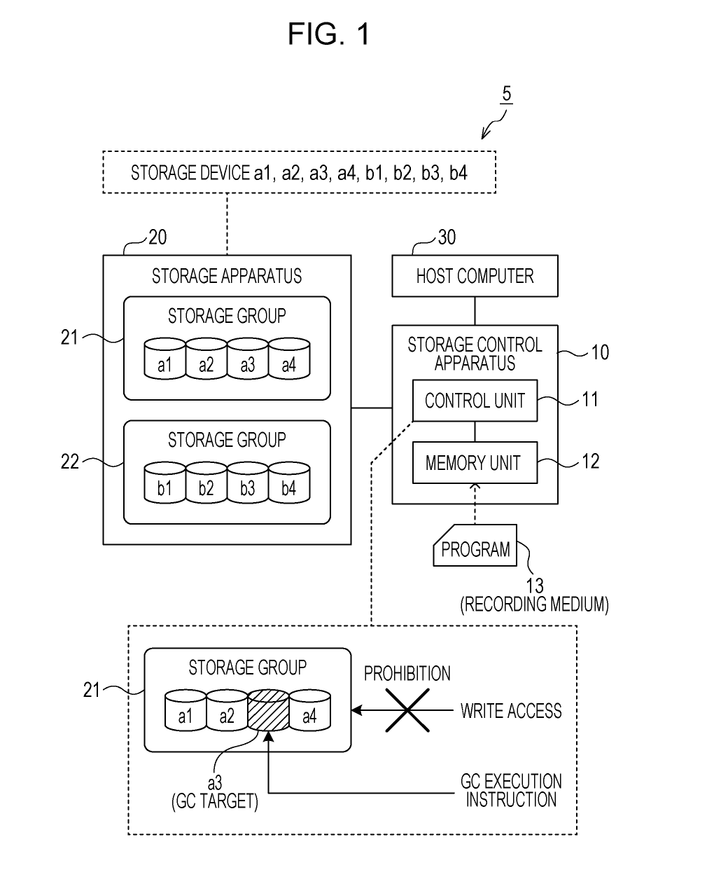

A first embodiment will be described with reference to FIG. 1. The first embodiment is related to control of GC for a storage group in a redundant configuration using multiple storage devices. FIG. 1 is a diagram illustrating an example of a storage system according to the first embodiment. A storage system 5 illustrated in FIG. 1 is an example of the storage system according to the first embodiment.

As illustrated in FIG. 1, the storage system 5 includes a storage control apparatus 10, a storage apparatus 20, and a host computer 30. An apparatus integrally including the storage control apparatus 10 and the storage apparatus 20 may be referred to as a storage apparatus.

The storage control apparatus 10 includes a control unit 11 and a memory unit 12. The control unit 11 is a processor such as a central processing unit (CPU), a digital signal processor (DSP), an application specific integrated circuit (ASIC), or a field programmable gate array (FPGA). The memory unit 12 is a memory device such as a random access memory (RAM), an HDD, an SSD, or a flash memory.

The memory unit 12 stores programs that control the operation of the storage control apparatus 10. The control unit 11 reads a program stored in the memory unit 12, and executes processing. The program may be recorded on a computer-readable recording medium 13. The recording medium 13 includes a magnetic storage device, an optical disc, and a semiconductor memory. The magnetic storage device includes a hard disk drive (HDD), a flexible disk (FD), and magnetic tape. The optical disc includes a compact disc-read only memory (CD-ROM), and a CD-recordable (R)/re-writable (RW).

Also, when the program is distributed, for instance, a portable recording medium (recording medium 13), such as a CD-ROM, on which the program is recorded is sold. Also, the program may be stored in a memory device of a server computer, and may be transferred from the server computer to another computer via a network. The storage control apparatus 10 may obtain the program from the recording medium 13, the server computer, or another computer, and may store the program in the memory unit 12.

The storage control apparatus 10 controls multiple storage devices a1, a2, a3, and a4 included in multiple storage groups 21, 22. The storage group 21 is made redundant by the storage devices a1, a2, a3, and a4. The storage group 22 is made redundant by the storage devices b1, b2, b3, and b4.

It is to be noted that the RAID group is an example of the storage groups 21, 22. Also, the SSD is an example of the storage device a1, a2, a3, a4, b1, b2, b3, and b4. In addition, a semiconductor device including a NAND flash memory or a memory element having rewrite characteristics (the property that overwriting is not possible) similar to the rewrite characteristics of a NAND flash memory is also an example of the storage devices a1, a2, a3, a4, b1, b2, b3, and b4.

The control unit 11 detects a first storage device of the storage devices a1, a2, a3, a4, b1, b2, b3, and b4, the first storage device including a target area on which GC is executed. In addition, the control unit 11 identifies the first storage group which is one of the storage groups 21, 22, and to which the first storage device belongs.

For instance, the control unit 11 detects a storage device including a target area of GC based on the number of spare blocks. As an example, when the number of the spare blocks of the storage device a3 is less than a predetermined value, the control unit 11 detects the storage device a3 as the first storage device. The control unit 11 then identifies the storage group 21 to which the storage device a3 belongs as the first storage group.

In addition, the control unit 11 prohibits write access to the storage devices belonging to the identified first storage group. The control unit 11 then instructs the first storage device to execute GC.

For instance, in the example above, write access to the storage devices a1, a2, a3, a4 belonging to the storage group 21 is prohibited, and the storage device a3 is instructed to execute GC.

Since the storage group 21 is in a redundant configuration, when the storage device a3 is detected as a GC target, it is probable that the number of spare blocks is reduced in at least one of the storage devices a1, a2, and a4.

For instance, when there are few spare blocks in the storage device a1, when write access is made to the storage device a1, there is a risk that the spare blocks are exhausted and response delay occurs.

However, in the first embodiment, when the storage device a3 is detected as a GC target, write access to the storage devices a1, a2, a3, and a4 belonging to the storage group 21 is prohibited. Therefore, risk of delay in responses is avoided.

It is to be noted that when a request for write access is received from the host computer 30 to the storage group 21 during execution of GC in the storage device a3, the control unit 11 may secure a save area in the storage group 22, and may perform writing of data on the save area according to the request. The first embodiment has been described so far.

### Second Embodiment

Next, a second embodiment will be described. The second embodiment is related to control of GC for a storage group in a redundant configuration using multiple storage devices.

[System]

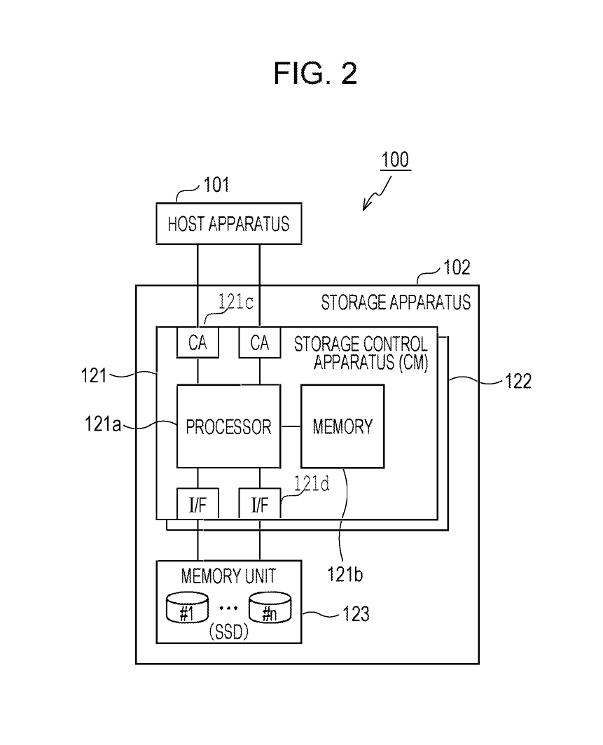

A storage system 100 will be described with reference to FIG. 2. FIG. 2 is a diagram illustrating an example of a storage system according to the second embodiment. It is to be noted that the storage system 100 illustrated in FIG. 2 is an example of the storage system according to the second embodiment.

As illustrated in FIG. 2, the storage system 100 includes a host apparatus 101 and a storage apparatus 102. The host apparatus 101 is a host computer such as a server apparatus and a personal computer (PC), for instance. The host apparatus 101 issues a request for write access or read access to the storage apparatus 102.

The storage apparatus 102 includes controller modules (CM) 121, 122, and a memory unit 123. It is to be noted that CMs 121, 122 are examples of a storage control apparatus. The number of CMs mounted in the storage apparatus 102 may be different from two. Hereinafter it is assumed that the CMs 121, 122 have substantially the same hardware and function, thus the CM 121 will be described, and a detailed description of the CM 122 is omitted.

The CM 121 includes a processor 121a, a memory 121b, multiple channel adapters (CA 121c), and multiple interfaces (I/F 121d). The CA is an adapter circuit that executes connection control between the host apparatuses 101. For instance, the CA is coupled via a communication line such as Fibre-Channel (FC) to a host bus adapter (HBA) mounted in the host apparatus 101 or a switch installed between the CA and the host apparatus 101. The I/F is an interface for coupling to the memory unit 123 via a line such as Serial Attached Small Computer System Interface (SCSI) (SAS) or Serial Advanced Technology Attachment (ATA) (SATA).

The processor 121a is, for instance, a CPU, a DSP, an ASIC, or an FPGA. The memory 121b is, for instance, a RAM, a HDD, an SSD, or a flash memory. It is to be noted that although the memory 121b is mounted internally of the CM 121 in the example of FIG. 2, a memory device coupled externally of the CM 121 may be utilized as part of the memory 121b.

The memory unit 123 includes multiple SSDs (#1, . . . , #n where n 2). In the memory unit 123, multiple redundant RAID groups may be set by combining multiple SSDs. A RAID apparatus is an example of the memory unit 123. Hereinafter, a description is given under the assumption that multiple RAID groups are set using the SSDs of the memory unit 123. Note that a RAID group may be abbreviated as a RAIDG.

The RAID level of the RAIDG is set to, for instance, RAIDs 1, 5, and 6 having a redundant configuration (fault-tolerant configuration). The RAID 1 is mirroring in which the same data is written to multiple recording media (SSDs in this example). The RAID 5 is a system to ensure redundancy by dispersedly recording parity data on multiple recording media (SSDs in this example). It is to be noted that the RAID 6 is a system to ensure redundancy utilizing parity data similarly to RAID 5, but generates parity data by a different calculation method and multiplexes the parity data.

It is to be noted that application range of the technique according to the second embodiment is not limited to the RAID 1, 5, and 6. However, in the case where access patterns to multiple SSDs resemble in a RAIDG having a redundant configuration, and as a consequence, multiple SSDs in the same RAIDG become GC targets, the technique according to the second embodiment contributes to the reduction of risk of delay in response. Consequently, the technique according to the second embodiment is preferably applied to a RAIDG having a redundant configuration.

[Function of Storage Control Apparatus]

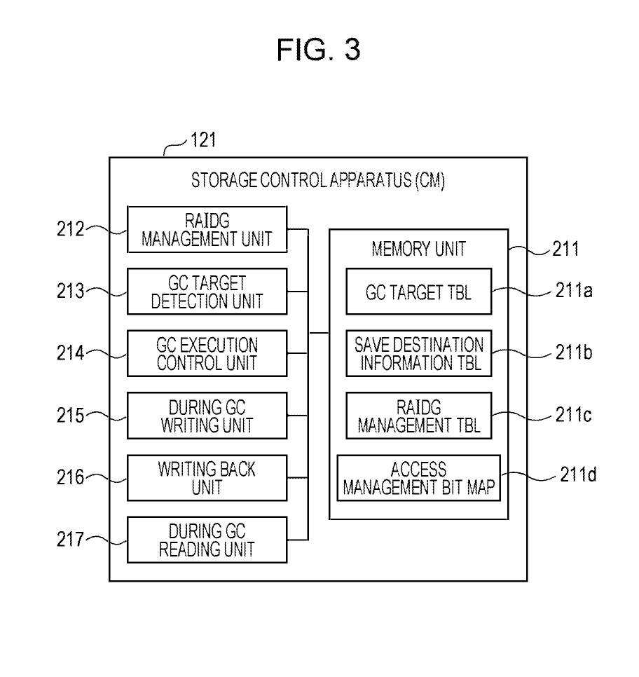

Here, the function of a storage control apparatus 121 will be described with reference to FIG. 3. FIG. 3 is a diagram illustrating an example of the function of the storage control apparatus.

As illustrated in FIG. 3, the storage control apparatus 121 includes a memory unit 211, a RAIDG management unit 212, a GC target detection unit 213, a GC execution control unit 214, a during GC writing unit 215, a writing back unit 216, and a during GC reading unit 217.

It is to be noted that the function of the memory unit 211 may be implemented by the memory 121b described above. The functions of the RAIDG management unit 212, the GC target detection unit 213, the GC execution control unit 214, the during GC writing unit 215, the writing back unit 216, and the during GC reading unit 217 may be implemented by the processor 121a described above.

The memory unit 211 stores a GC target table 211a, a save destination information table 211b, a RAIDG management table 211c, and an access management bit map 211d. For the sake of notation, a table may be denoted as TBL, and a bit map may be denoted as BM.

[GC Target Table 211a]

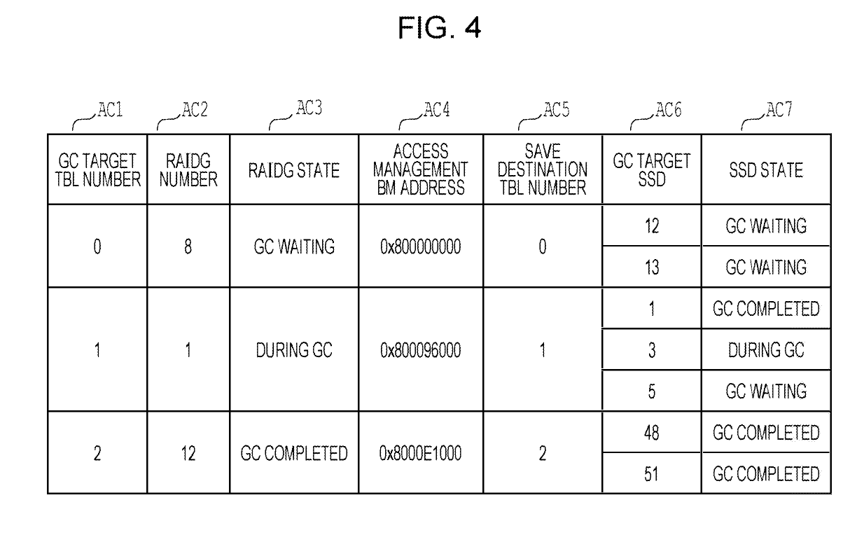

The GC Target Table 211a records information related to each RAIDG (GC target RAIDG) as a GC target, and each SSD (GC target SSD AC6) as a GC target. For instance, the GC target table 211a has the contents as illustrated in FIG. 4. FIG. 4 is a table illustrating an example of the GC target table.

The GC target table 211a includes items: GC target TBL number AC1, RAIDG number AC2, RAIDG state AC3, access management BM address AC4, save destination TBL number AC5, GC target SSD AC6, and SSD state AC7. The GC target TBL number AC1 is identification information for identifying each of the records in the GC target table 211a. The RAIDG number is identification information for identifying each RAIDG. It is to be noted that each RAIDG number AC2 recorded in the GC target table 211a is the RAIDG number of a GC target RAIDG.

The RAIDG state AC3 indicates a state of a RAIDG related to GC, the state being one of “GC waiting”, “during GC”, and “GC completed”. The “GC waiting” indicates a state where GC is not being executed for any of the GC target SSDs belonging to the relevant RAIDG, and GC has never been executed for at least one of the GC target SSDs. For instance, a state where an SSD with GC never executed and an SSD with GC completed are both present is the “GC waiting”.

The “during GC” indicates a state where GC is being executed for one of the GC target SSDs belonging to the relevant RAIDG. For instance, each of the following states is the “during GC”: a state where an SSD during execution of GC and an SSD with GC never executed are both present, a state where an SSD during execution of GC and an SSD with GC completed are both present, and a state where an SSD during execution of GC, an SSD with GC never executed, and an SSD with GC completed are all present.

The “GC completed” indicates a state where GC is completed for all the GC target SSDs belonging to the RAIDG. The access management BM address AC4 indicates the physical address of a memory 121b in which an access management bit map 211d is stored. The access management bit map 211d is a management BM for managing whether writing back of data saved during GC is completed for the logical volumes (LV) disposed in the target GC RAIDG. The management BM is provided to each GC target RAIDG. The saving and writing back of data, and the management of the BM will be described later.

The save destination TBL number AC5 is identification information for identifying each of records of the save destination information table 211b that records information related to a save area in which data is saved during GC. The column the GC target SSD AC6 stores identification information for identifying an SSD which is determined to be a GC target SSD.

The SSD state AC7 indicates a state of each SSD related to GC, the state being one of “GC waiting”, “during GC”, and “GC completed”. The “GC waiting” indicates a state where GC has never been executed for the relevant GC target SSD. The “during GC” indicates a state where GC is being executed for the relevant GC target SSD. The “GC completed” indicates a state where GC has been completed for the relevant GC target SSD.

[Save Destination Information Table 211b]

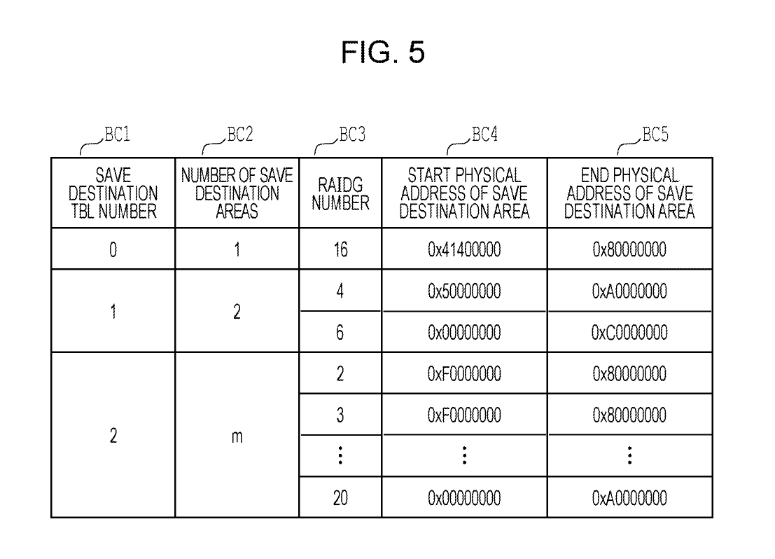

When a request for write access to a RAIDG during GC execution is received, the save destination information table 211b records information related to save destination area which is secured in another RAIDG as a temporary write destination (save destination) for data. For instance, the save destination information table 211b has the contents as illustrated in FIG. 5. FIG. 5 is a table illustrating an example of the save destination information table.

The save destination information table 211b includes items: save destination TBL number BC1, the number of save destination areas BC2, RAIDG number BC3, start physical address of save destination area BC4, and end physical address of save destination area BC5. The save destination TBL number BC1 is identification information for identifying each of the records in the save destination information table 211b. The number of save destination areas BC2 indicates the number of areas at a save destination corresponding to each save destination TBL number BC1. When a save destination area is secured from each of multiple RAIDGs, the number of save destination areas BC2 is two or greater.

The RAIDG number is identification information for identifying each RAIDG. It is to be noted that each RAIDG number BC3 recorded in the save destination information table 211b is the RAIDG number of a RAIDG having a save destination area. The start physical address and the end physical address of the save destination area are the physical addresses of the relevant RAIDG corresponding to the start and end of a save destination area. It is to be noted that instead of the end physical address, the capacity of the save destination area may be recorded in the save destination information table 211b.

As described above, save destination areas may be secured from multiple RAIDGs for one GC target RAIDG. For instance, in the example of FIGS. 4 and 5, save destination areas are secured from two RAIDGs (RAIDG numbers 4, 6) for the GC target RAIDG (save destination TBL number=1) with RAIDG number 1. In this case, the number of save destination areas BC2 is two.

(RAIDG Management Table 211c)

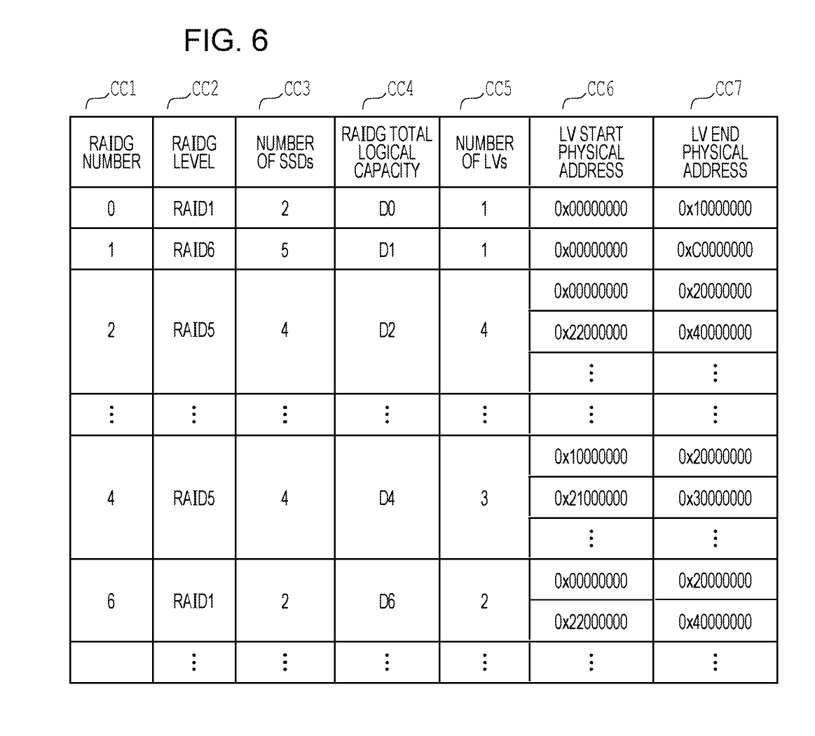

The RAIDG management table 211c records information related to each RAIDG and LV set in the memory unit 123. For instance, the RAIDG management table 211c has the contents as illustrated in FIG. 6. FIG. 6 is a table illustrating an example of the RAID group management table.

The RAIDG management table 211c includes items: RAIDG number CC1, RAID level CC2, the number of SSDs CC3, RAIDG total logical capacity CC4, the number of LVs CC5, LV start physical address CC6, and LV end physical address CC7. The RAIDG number CC1 is identification information for identifying each RAIDG. The column of RAID level CC2 stores a RAID level set in the relevant RAIDG. The number of SSDs CC3 is the number of SSDs included in the relevant RAIDG.

The RAIDG total logical capacity CC4 indicates the total capacity which may be secured for LV in the relevant RAIDG. The number of LVs CC5 indicates the number of LVs disposed in the relevant RAIDG. The LV start physical address CC6 is the physical address, which indicates the start position of LV, of the relevant RAIDG. The LV end physical address CC7 is the physical address, which indicates the end position of LV, of the relevant RAIDG. It is to be noted that instead of the LV end physical address CC7, the LV logical capacity may be recorded in the RAIDG management table 211c.

[RAIDG Management Unit 212]

The RAIDG management unit 212 updates the RAIDG management table 211c at the time of setting a RAIDG and an LV. For instance, when a RAIDG is created, the RAIDG management unit 212 records in the RAIDG in the RAIDG management table 211c: a RAID level CC2 set in the RAIDG, the number of SSDs CC3 (number of SSDs) forming the RAIDG, and the total capacity (RAIDG total logical capacity CC4) which may be secured for LV.

In addition, when an LV is created in the RAIDG, the RAIDG management unit 212 records the physical position (the LV start physical address CC6, the LV end physical address CC7) of the LV in the RAIDG management table 211c. It is to be noted that the RAIDG management unit 212 may record the capacity of the LV (the LV logical capacity), instead of the LV end physical address CC7, in the RAIDG management table 211c. Also, the RAIDG management unit 212 increments the number of LVs CC5 of the relevant RAIDG by one.

On the other hand, when an LV is deleted, the RAIDG management unit 212 deletes the physical position (the LV start physical address CC6, the LV end physical address CC7) of the LV to be deleted from the RAIDG management table 211c. Also, the RAIDG management unit 212 decrements the number of LVs CC5 of the relevant RAIDG by one. Also, when a RAIDG is deleted, the RAIDG management unit 212 deletes the RAID level CC2, the number of SSDs CC3, and the RAIDG total logical capacity CC4 from the RAIDG management table 211c.

[GC Target Detection Unit 213]

The GC target detection unit 213 issues a state acquisition instruction (command) to each SSD of the memory unit 123. The state acquisition instruction is a command to each SSD for reporting a proportion (proportion of spare blocks) of unused spare blocks to the total capacity of SSDs. The GC target detection unit 213 acquires a proportion of spare blocks reported from each SSD according to the state acquisition instruction. It is to be noted that the GC target detection unit 213 issues a state acquisition instruction on a regular basis. For instance, the period of issuance is set to approximately several minutes. Alternatively, the period of issuance may be adjusted by a user operation.

The GC target detection unit 213 compares the proportion of spare blocks with a predetermined value for each SSD. When the proportion of spare blocks is smaller than the predetermined value, the GC target detection unit 213 identifies the RAIDG including the SSD which has reported the proportion of spare blocks, and determines that the identified RAIDG is the GC target RAIDG. The GC target detection unit 213 then records information on the GC target RAIDG in the GC target table 211a (see FIG. 4).

The predetermined value may be determined by the following method. First, the GC target detection unit 213 issues a state acquisition instruction to each SSD, and acquires the proportion of spare blocks of the SSD, and information on whether or not the SSD is executing autonomous GC. The period of issuance of the state acquisition instruction is set to approximately several minutes, for instance. Alternatively, the period of issuance may be adjusted by a user operation. In addition, the GC target detection unit 213 calculates a value obtained by adding a margin to the proportion of spare blocks of each acquired SSD, and sets a predetermined value based on the calculated value. The margin may be set to several tens %, for instance, and adjustment of the margin by a user operation may be allowed.

[GC Execution Control Unit 214]

The GC execution control unit 214 monitors the state of the GC target RAIDG on a regular basis. The period of monitoring is set to approximately several minutes, for instance. Alternatively, the period of monitoring may be adjusted by a user operation. At a monitoring timing, for each RAIDG recorded in the RAIDG management table 211c, the GC execution control unit 214 checks to see whether a corresponding RAIDG number AC2 is recorded in the GC target table 211a. When the RAIDG number AC2 and the “GC waiting” state are recorded in the GC target table 211a, the GC execution control unit 214 executes the following processing.

First, the GC execution control unit 214 secures a save destination area for the GC target RAIDG by the following method. The GC execution control unit 214 calculates the total capacity (LV logical capacity) of the LVs disposed in each GC target RAIDG from the RAIDG management table 211c. In addition, the GC execution control unit 214 refers to the RAIDG management table 211c, and for each RAIDG other than the GC target RAIDG, compares the RAIDG total logical capacity CC4 with the LV logical capacity which is calculable from the LV start physical address CC6 and the LV end physical address CC7 to identify each RAIDG having an unused area.

In addition, the GC execution control unit 214 selects at least one RAIDG capable of providing an unused area for storing data with the LV logical capacity of the GC target RAIDG. The GC execution control unit 214 secures the unused area of each selected RAIDG as the save destination area.

When the save destination area is secured, the GC execution control unit 214 records the RAIDG number BC3 of the RAIDG that provides the save destination area, and the start physical address and the end physical address of the save destination area (or the capacity of the save destination area) in the save destination information table 211b. In addition, the GC execution control unit 214 records the number of save destination areas BC2 in association with the save destination TBL number BC1. Also, the GC execution control unit 214 records a corresponding save destination TBL number AC5 in the GC target table 211a in association with the RAIDG number AC2 of the GC target RAIDG.

In addition, the GC execution control unit 214 secures on the memory 121b an area for storing the access management bit map 211d for the GC target RAIDG corresponding to the secured save destination area. The size of the secured area here is the one by which the area for the LV logical capacity of the GC target RAIDG is manageable. It is to be noted that the size (the management size, for instance, 1 MB) manageable by one bit of the access management bit map 211d is pre-set. Therefore, the size of the secured area is the number of bits for (LV logical capacity/management size).

When an area for the access management bit map 211d is secured, the GC execution control unit 214 records the address of the memory 121b indicating the position of the secured area in the GC target table 211a as the access management BM address AC4. Also, the GC execution control unit 214 sets the RAIDG state AC3 of the GC target RAIDG to “during GC” in the GC target table 211a.

The GC execution control unit 214 issues a command (GC command) to the GC target SSDs belonging to the GC target RAIDG for execution of GC. Also, the GC execution control unit 214 sets the SSD state AC7 of the GC target SSD AC6 at the destination of the GC command to “during GC” in the GC target table 211a.

It is to be noted that the GC command is issued to one or two SSDs according to a RAID level CC2. For instance, when the RAID level CC2 of the GC target RAIDG is 1 or 5, the GC command is issued to one SSD. On the other hand, when the RAID level CC2 of the GC target RAIDG is 6, it is possible for the GC execution control unit 214 to issue a GC command to one or two SSDs at the same time.

When receiving response of GC completion, the GC execution control unit 214 sets the SSD state AC7 of each SSD with GC completed to “GC completed”. The GC execution control unit 214 sequentially issues a GC command to each GC target SSD according to GC completion.

After GC is completed for all GC target SSDs belonging to a RAIDG “during GC”, the GC execution control unit 214 updates the GC target table 211a, and sets the state of the RAIDG to “GC completed”.

For each RAIDG in the “GC completed” state, the GC execution control unit 214 starts to write back the data in the save destination area. It is to be noted that the processing to write back is executed by the later-described writing back unit 216.

When all writing back is completed by the writing back unit 216, the GC execution control unit 214 releases the area of the access management bit map 211d on the memory 121b. In addition, the GC execution control unit 214 releases the save destination area for which writing back is completed. Also, the GC execution control unit 214 deletes the information on the relevant RAIDG from the GC target table 211a.

[During GC Writing Unit 215]

The during GC writing unit 215 processes a write request to the LV of a RAIDG in the “during GC” state.

When receiving the write request, the during GC writing unit 215 refers to the access management bit map 211d, and checks a bit value corresponding to the range (write request range) of LV specified in the write request. The during GC writing unit 215 then determines whether saving of data to the save destination area for the write request range is made based on the checked bit value. It is to be noted that each bit value of the access management bit map 211d corresponds to data with the management size.

When it is determined that saving of data to the save destination area for the write request range has not been made, the during GC writing unit 215 executes processing (merge processing) to adjust data size so that the size of data to be written becomes the management size. For instance, when the size of data in the write request falls below the management size, the during GC writing unit 215 reads data as a supplement to the management size from the RAIDG in the “during GC” state, and merges the data with the data in the write request, the supplement being the difference between the management size and the size of the data in the write request.

When data is read from the RAIDG in the “during GC” state, the during GC writing unit 215 reads data from each SSD other than the SSDs in the “during GC” state. For instance, when the RAID level CC2 of a RAIDG is 5, the during GC writing unit 215 reads the parity data of each target SSD to reconstruct the data, and executes the merge processing using the data.

The during GC writing unit 215 refers to the RAIDG management table 211c, and calculates a logical capacity offset in the write request range from the position information (the LV start physical address CC6, the LV end physical address CC7) of the LV. In addition, the during GC writing unit 215 refers to the save destination information table 211b, and acquires the position information (the start physical address of the save destination area, the end physical address of the save destination area) on the save destination area.

It is to be noted that the position information on the LV is often represented by an offset (logical capacity offset) in which the logical block address (LBA) indicating the start position is zero. Thus, in the present description, the position information is represented using the logical capacity offset. However, a method of representing position information is not limited to this example.

In addition, the during GC writing unit 215 identifies the physical position of each of the RAIDG of the save destination area and the write request range based on the logical capacity offset, the position information on the save destination area, the RAID level CC2, and the number of SSDs CC3. The during GC writing unit 215 then writes the data adjusted to the management size by the merge processing to the identified physical position.

After the data is written, the during GC writing unit 215 sets the bit value of the access management bit map 211d corresponding to the write destination to a bit value indicating “data saved”. The setting allows a target range to be written back after GC to be identified.

When it is determined that saving of data to the save destination area for the write request range has been made, the during GC writing unit 215 refers to the RAIDG management table 211c, and calculates a logical capacity offset in the write request range from the position information (the LV start physical address CC6, the LV end physical address CC7) of the LV. In addition, the during GC writing unit 215 refers to the save destination information table 211b, and obtains the position information (the start physical address of the save destination area, the end physical address of the save destination area) on the save destination area.

In addition, the during GC writing unit 215 identifies the physical position of each of the RAIDG of the save destination area and the write request range based on the logical capacity offset, the position information on the save destination area, the RAID level CC2, and the number of SSDs CC3. The during GC writing unit 215 then writes the data in the write request to the save destination area without performing the merge processing.

[Writing Back Unit 216]

For each RAIDG in the “GC completed” state, the writing back unit 216 executes write back processing for the data in the save destination area.

The writing back unit 216 refers to the access management bit map 211d, and calculates a logical capacity offset of the save destination area. In addition, the writing back unit 216 refers to the save destination information table 211b, and obtains the position information (the start physical address of the save destination area, the end physical address of the save destination area) on the save destination area.

In addition, the writing back unit 216 identifies the physical position of the RAIDG of the save destination area based on the logical capacity offset, the position information on the save destination area, the RAID level CC2, and the number of SSDs CC3. Also, the writing back unit 216 reads data from the identified save destination area, and writes the data to the physical position of the RAIDG in the “GC completed” state.

[During GC Reading Unit 217]

The during GC reading unit 217 processes a read request to the LV of a RAIDG in the “during GC” state.

When receiving the read request, the during GC reading unit 217 refers to the RAIDG management table 211c, and identifies the position information on the LV and the logical capacity offset specified in the read request. In addition, the during GC reading unit 217 checks a bit value of the access management bit map 211d corresponding to a read source. The during GC reading unit 217 then determines based on the checked bit value whether the read request is made to a range for which valid data is stored in the save destination area.

When the read request is made to a range for which valid data is stored in the save destination area, the during GC reading unit 217 identifies the physical position of the save destination area based on the logical capacity offset, the save destination information table 211b, and the RAIDG management table 211c. In addition, the during GC reading unit 217 reads data from the identified physical position, and returns response to the read request using the read data.

When the read request is made to a range (range not saved) for which valid data is stored not in the save destination area but at the original read source, the during GC reading unit 217 identifies the physical position from the position information on the LV specified in the read request and the RAIDG management table 211c. The during GC reading unit 217 reads data from the physical position of the identified read source, and returns response to the read request using the read data.

When the physical position of the read source contains an SSD in the “during GC” state, the during GC reading unit 217 reconstructs the data to be read using the data read from each SSD not in the “during GC” state. For instance, when the RAID level CC2 is 5, the during GC reading unit 217 reconstructs the data to be read using data such as parity data read from each SSD not in the “during GC” state. The during GC reading unit 217 then returns response to the read request using the reconstructed data.

As described above, write access is prohibited RAIDG by RAIDG during GC, and data is saved in the save destination area, thereby making it possible to reduce risk of having write access to an SSD in which it is probable that spare blocks are exhausted. The risk of delay in response is reduced by controlling GC with this method.

[Flow of Processing]

Next, the flow of processing for the above-described GC control will be described.

[Detection of GC Target RAID Group]

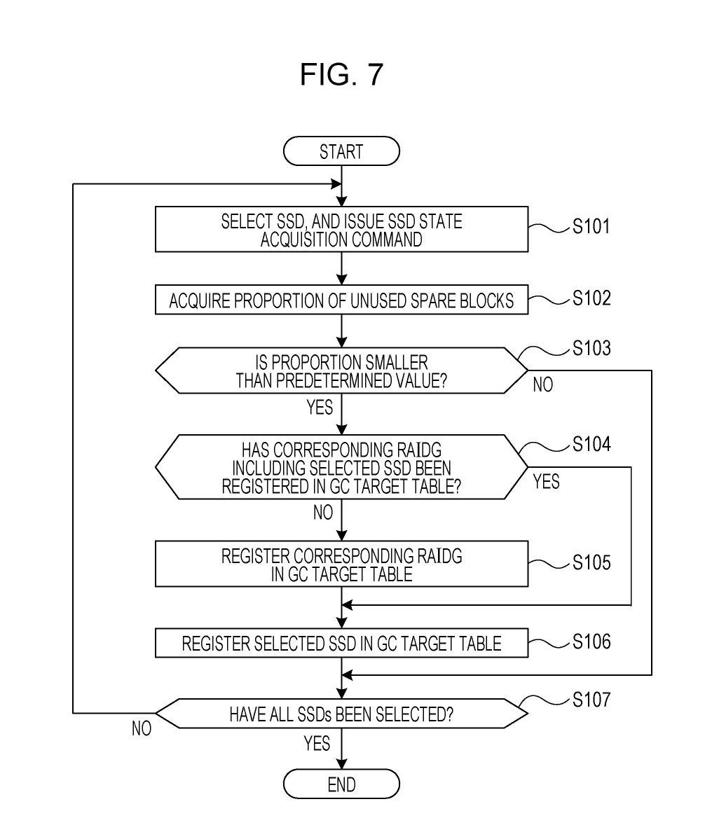

The flow of processing related to detection of a GC target RAIDG will be described with reference to FIG. 7. FIG. 7 is a flowchart illustrating the flow of processing related to detection of a GC target RAID group. The processing illustrated in FIG. 7 is executed by the above-described GC target detection unit 213 on a regular basis. For instance, the period of execution is set to approximately several minutes. The period of execution may be adjusted by a user.

(S101) The GC target detection unit 213 selects an SSD of the memory unit 123, and issues a state acquisition instruction (command) to the selected SSD (selection SSD). The state acquisition instruction is a command to each SSD for reporting a proportion (proportion of spare blocks) of unused spare blocks to the total capacity of SSDs.

(S102) The GC target detection unit 213 acquires a proportion of spare blocks (proportion of unused spare blocks) reported from the selection SSD according to the state acquisition instruction.

(S103) The GC target detection unit 213 compares the proportion of spare blocks with a predetermined value of the selection SSD, and determines whether or not the proportion of spare blocks is smaller than a predetermined value. Setting of a predetermined value will be described later. When the proportion of spare blocks is smaller than the predetermined value, the processing proceeds to S104. On the other hand, when the proportion of spare blocks is not smaller than the predetermined value, the processing proceeds to S107.

(S104) The GC target detection unit 213 identifies the RAIDG (the relevant RAIDG) which includes the SSD, and determines that the identified RAIDG is the GC target RAIDG. The GC target detection unit 213 then determines whether or not the RAIDG has been registered in the GC target table 211a. When the RAIDG has been registered in the GC target table 211a, the processing proceeds to S106. On the other hand, when the RAIDG has not been registered in the GC target table 211a, the processing proceeds to S105.

(S105) The GC target detection unit 213 registers the relevant RAIDG in the GC target table 211a.

(S106) The GC target detection unit 213 registers the selection SSD in the GC target table 211a.

(S107) The GC target detection unit 213 determines whether or not all SSDs of the memory unit 123 have been selected. When all SSDs have been selected, a series of processing illustrated in FIG. 7 is completed. On the other hand, when an SSD has not been selected, the processing proceeds to S101.

[Setting of Predetermined Value]

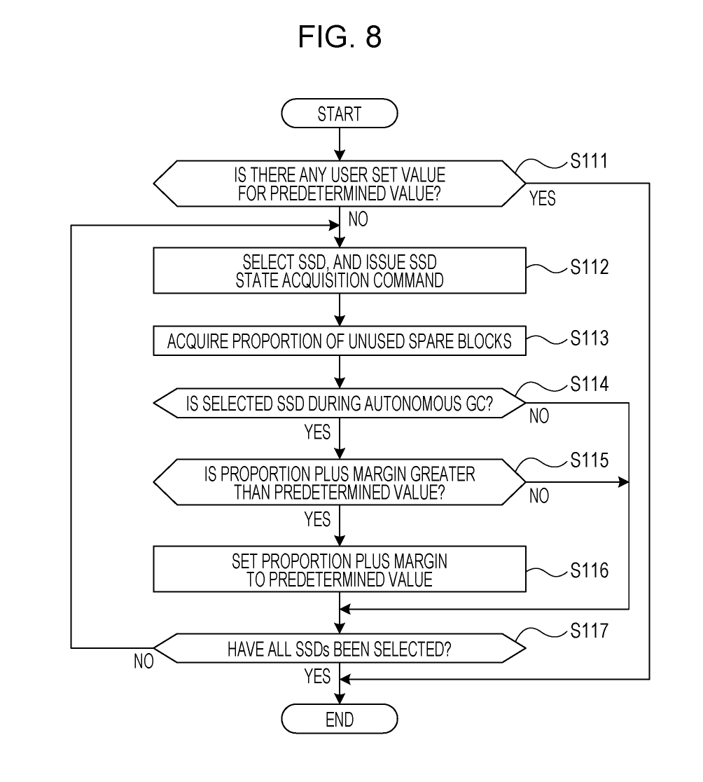

Next, the flow of processing related to the above-mentioned setting of a predetermined value will be described with reference to FIG. 8. FIG. 8 is a flowchart illustrating the flow of processing related to setting a predetermined value. It is to be noted that the processing illustrated in FIG. 8 is executed by the above-described GC target detection unit 213 on a regular basis. For instance, the period of execution is set to approximately several minutes. The period of execution may be adjusted by a user.

(S111) The GC target detection unit 213 determines whether or not a user setting value (value pre-set by a user in advance) for the above-mentioned predetermined value is present. When a user setting value for the predetermined value is present, a series of processing illustrated in FIG. 8 is completed. In this case, the user setting value is utilized as the predetermined value. On the other hand, when a user setting value for the predetermined value is not present, the processing proceeds to S112.

(S112) The GC target detection unit 213 selects an SSD of the memory unit 123. In addition, the GC target detection unit 213 issues the above-described state acquisition instruction to the selection SSD.

(S113) The GC target detection unit 213 acquires a proportion of spare blocks (proportion of unused spare blocks) reported from the selection SSD, and information indicating whether or not autonomous GC of the SSD is in operation, according to the state acquisition instruction.

(S114) The GC target detection unit 213 determines whether or not the selection SSD is executing autonomous GC. The autonomous GC is the one that is autonomously executed by an SSD according to a proportion of spare blocks without an execution command for GC issued by the storage control apparatuses 121, 122. When the selection SSD is during autonomous GC, the processing proceeds to S115. On the other hand, when the selection SSD is not during autonomous GC, the processing proceeds to S117.

(S115) The GC target detection unit 213 calculates a value obtained by adding a margin to the proportion of spare blocks of the acquired selection SSD. The margin may be set to several tens %, for instance, and adjustment of the margin by a user operation may be allowed. In addition, the GC target detection unit 213 determines whether or not the calculated value is greater than the current predetermined value. When the calculated value is greater than the current predetermined value, the processing proceeds to S116. On the other hand, when the calculated value is not greater than the current predetermined value, the processing proceeds to S117.

(S116) The GC target detection unit 213 sets a value to a predetermined value, the value being obtained by adding a margin to the proportion of spare blocks of the acquired selection SSD.

(S117) The GC target detection unit 213 determines whether or not all SSDs of the memory unit 123 have been selected. When all SSDs of the memory unit 123 have been selected, a series of processing illustrated in FIG. 8 is completed. On the other hand, when an SSD has not been selected, the processing proceeds to S112.

[Execution of GC]

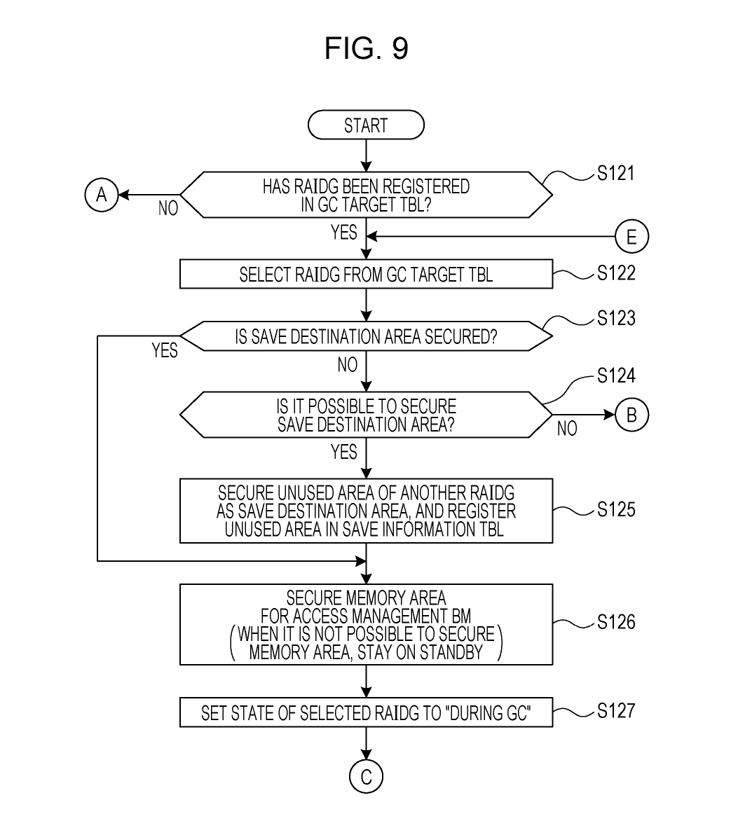

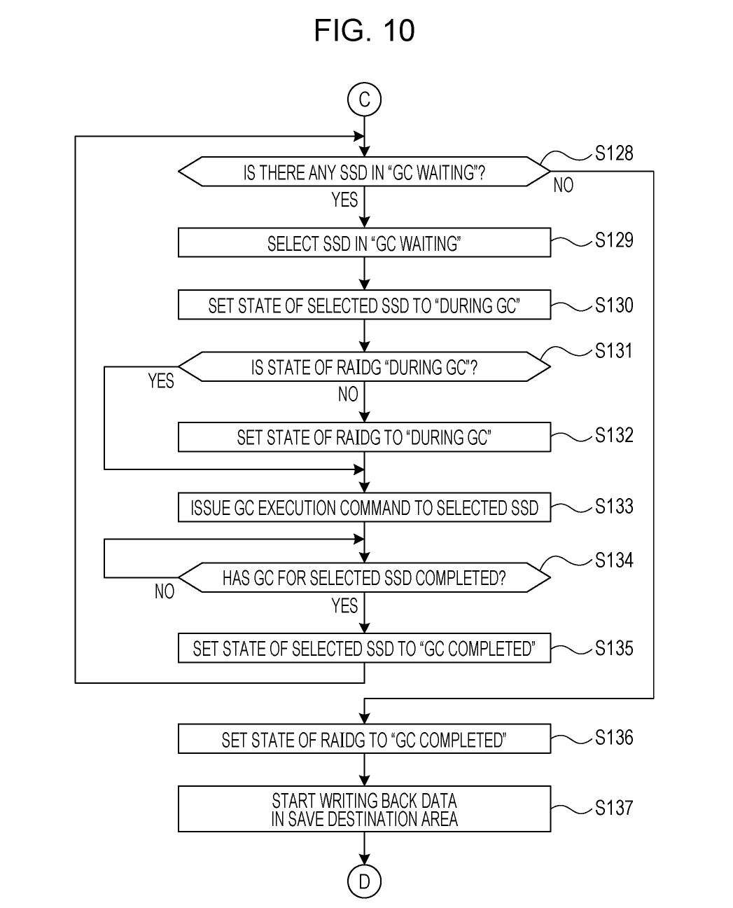

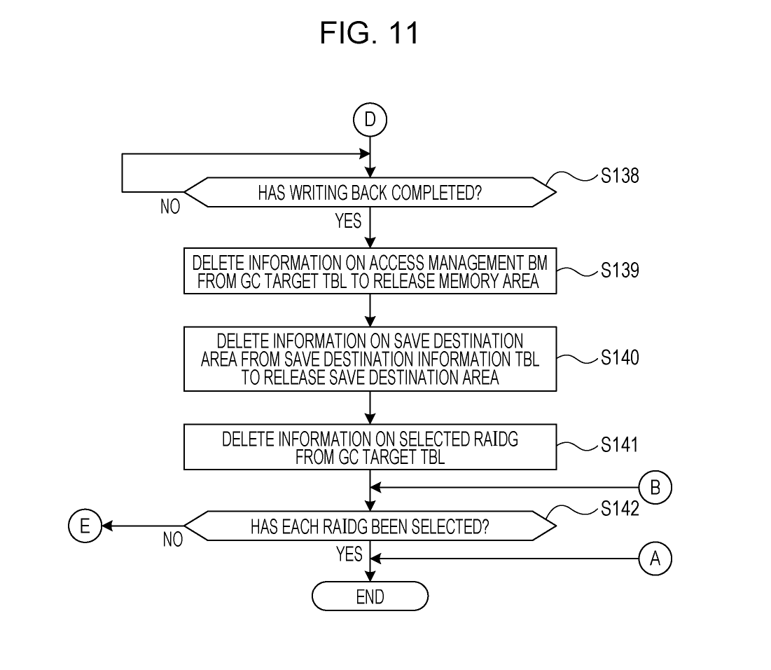

Next, the flow of processing related to execution of GC will be described with reference to FIGS. 9 to 11. FIG. 9 is a first flowchart illustrating the flow of processing related to execution of GC. FIG. 10 is a second flowchart illustrating the flow of processing related to execution of GC. FIG. 11 is a third flowchart illustrating the flow of processing related to execution of GC.

The GC execution control unit 214 monitors the state of the GC target RAIDG on a regular basis. The period of monitoring is set to approximately several minutes, for instance. Alternatively, the period of monitoring may be adjusted by a user operation. At a monitoring timing, the GC execution control unit 214 starts the processing in and after S121 illustrated in FIGS. 9 to 11.

(S121) The GC execution control unit 214 determines whether or not a RAIDG is registered in the GC target table 211a. For instance, for each RAIDG recorded in the RAIDG management table 211c, the GC execution control unit 214 checks to see whether a corresponding RAIDG number AC2 is recorded in the GC target table 211a. When a RAIDG is registered in the GC target table 211a and the RAIDG is in the “GC waiting” state, the processing proceeds to S122. On the other hand, when no RAIDG is registered in the GC target table 211a, a series of processing illustrated in FIGS. 9 to 11 is completed.

(S122) The GC execution control unit 214 selects a RAIDG from the GC target table 211a.

(S123) The GC execution control unit 214 refers to the GC target table 211a and the save destination information table 211b, and determines whether or not a save destination area is secured for the selection RAIDG. When a save destination area is secured, the processing proceeds to S126. On the other hand, when a save destination area is not secured, the processing proceeds to S124.

(S124) The GC execution control unit 214 determines whether or not a save destination area may be secured from the RAIDGs other than the selection RAIDG (other RAIDGs). For instance, the GC execution control unit 214 calculates the total capacity (LV logical capacity) of the LVs disposed in each GC target RAIDG from the RAIDG management table 211c. In addition, the GC execution control unit 214 refers to the RAIDG management table 211c, and for each RAIDG other than the GC target RAIDG, compares the RAIDG total logical capacity CC4 with the LV logical capacity which is calculable from the LV start physical address CC6 and the LV end physical address CC7 to search for a RAIDG having an unused area.

When a save destination area may be secured, the processing proceeds to S125. On the other hand, when a save destination area may not be secured, the processing proceeds to S142.

(S125) The GC execution control unit 214 secures an unused area of other RAIDGs as the save destination area, and registers information on the save destination area in the save destination information table 211b. It is to be noted that the number of other RAIDGs used for securing a save destination area may be two or greater.

For instance, the GC execution control unit 214 records the RAIDG number BC3 of the RAIDG that provides the save destination area, and the start physical address and the end physical address of the save destination area (or the capacity of the save destination area) in the save destination information table 211b. In addition, the GC execution control unit 214 records the number of save destination areas BC2 in association with the save destination TBL number BC1. Also, the GC execution control unit 214 records a corresponding save destination TBL number AC5 in the GC target table 211a in association with the RAIDG number AC2 of the GC target RAIDG.

(S126) The GC execution control unit 214 secures on the memory 121b an area for storing the access management bit map 211d for the GC target RAIDG, corresponding to the secured save destination area. The size of the secured area here is the one by which the area for the LV logical capacity of the GC target RAIDG is manageable.

When a memory area for the access management bit map 211d is not secured, the GC execution control unit 214 stays on standby until a free area is secured on the memory 121b. When an area for the access management bit map 211d is secured, the GC execution control unit 214 records the address of the memory 121b indicating the position of the secured area in the GC target table 211a as the access management BM address AC4.

(S127) The GC execution control unit 214 sets the RAIDG state AC3 of the selection RAIDG to “during GC” in the GC target table 211a. When the processing of S127 is completed, the processing proceeds to S128 (see FIG. 10).

(S128) The GC execution control unit 214 determines whether or not an SSD in “GC waiting” is present in the selection RAIDG. When an SSD in “GC waiting” is present, the processing proceeds to S129. On the other hand, when no SSD in “GC waiting” is present, the processing proceeds to S136.

(S129) The GC execution control unit 214 selects an SSD in the “GC waiting” state from the selection RAIDG.

(S130) The GC execution control unit 214 sets the SSD state AC7 of the selection SSD to “during GC” in the GC target table 211a.

(S131) The GC execution control unit 214 determines whether or not the state of the selection RAIDG is “during GC”. When the state of the selection RAIDG is “during GC”, the processing proceeds to S133. On the other hand, when the state of the selection RAIDG is not “during GC”, the processing proceeds to S132.

(S132) The GC execution control unit 214 sets the state of the selection RAIDG “during GC”.

(S133) The GC execution control unit 214 issues a command (GC command) to the selection SSD for execution of GC.

It is to be noted that the GC command is issued to one or two SSDs according to a RAID level CC2. For instance, when the RAID level CC2 of the GC target RAIDG is 1 or 5, the GC command is issued to one SSD. On the other hand, when the RAID level CC2 of the GC target RAIDG is 6, it is possible for the GC execution control unit 214 to issue a GC command to one or two SSDs at the same time. Therefore, when the RAID level CC2 is 6, two SSDs may be selected by the processing in S129, and in this case, the GC command is issued to two selection SSDs by the processing in S133.

(S134) The GC execution control unit 214 determines whether or not GC of the selection SSD is completed. For instance, the GC execution control unit 214 waits for a response of GC completion from the selection SSD. When a response of GC completion is received from all selection SSDs, the processing proceeds to S135. On the other hand, when no response of GC completion is received from a selection SSD, the determination in S134 is made again.

(S135) The GC execution control unit 214 sets the SSD state AC7 of each SSD with GC completed to “GC completed”. When the processing in S135 is completed, the processing proceeds to S128.

(S136) The GC execution control unit 214 sets the state of the selection RAIDG to “GC completed”.

(S137) For each RAIDG in the state of “GC completed”, the GC execution control unit 214 starts to write back the data in a corresponding save destination area. The processing to write back will be described later. The processing to write back is executed by the writing back unit 216.

(S138) The GC execution control unit 214 determines whether or not write back by the writing back unit 216 is completed. When write back is completed, the processing proceeds to S139 (see FIG. 11). On the other hand, when write back is not completed, the determination in S138 is made again. That is, the GC execution control unit 214 waits for completion of write back.

(S139) The GC execution control unit 214 deletes information on the access management bit map 211d related to the selection RAIDG from the GC target table 211a. Also, the GC execution control unit 214 releases the area (memory area) secured on the memory 121b for the access management bit map 211d.

(S140) The GC execution control unit 214 deletes information on the save destination area for the selection RAIDG from the save destination information table 211b. In addition, the GC execution control unit 214 releases the save destination area secured in other RAIDGs for the selection RAIDG.

(S141) The GC execution control unit 214 deletes the information on the selection RAIDG from the GC target table 211a.

(S142) The GC execution control unit 214 determines whether or not each RAIDG in the RAIDG management table 211c has been selected. When each RAIDG has been selected, a series of processing illustrated in FIGS. 9 to 11 is completed. On the other hand, when unselected RAIDG is present, the processing proceeds to S122.

[Write Access]

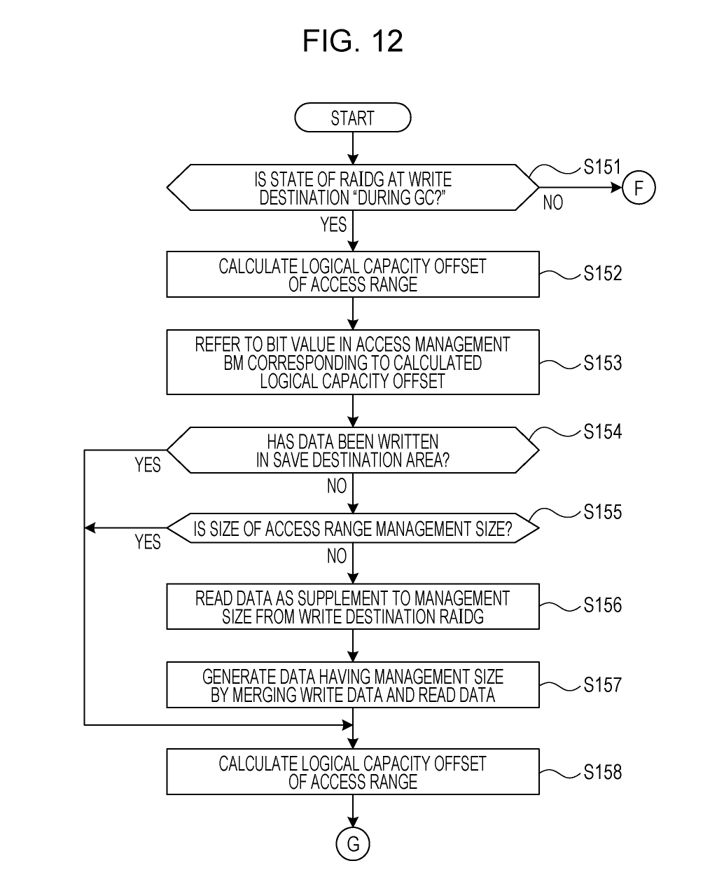

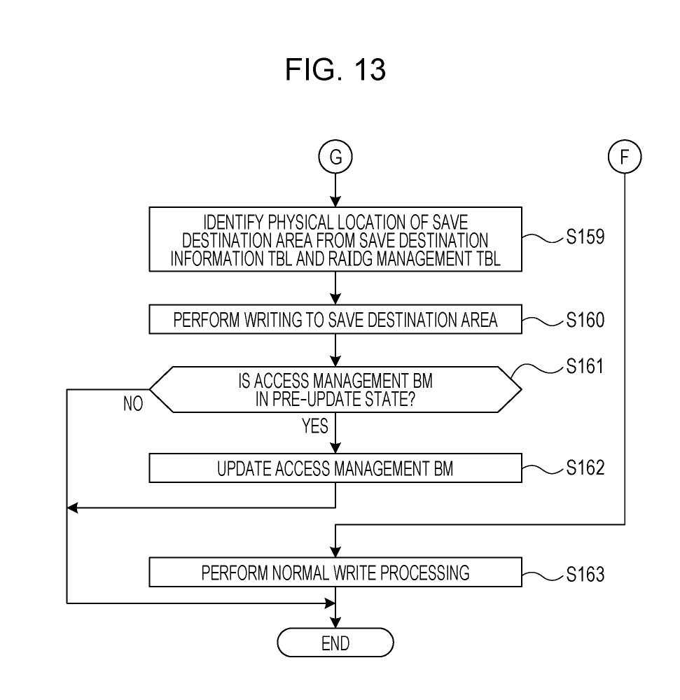

Next, the flow of processing according to a request for write access will be described with reference to FIGS. 12 and 13. FIG. 12 is a first flowchart illustrating the flow of processing according to a request for write access. FIG. 13 is a second flowchart illustrating the flow of processing according to a request for write access.

(S151) The during GC writing unit 215 in GC refers to the GC target table 211a, and determines whether or not the state of a write destination RAIDG corresponding to the write destination (access range) specified in the request for write access is “during GC”. When the state of the write destination RAIDG is “during GC”, the processing proceeds to S152. On the other hand, when the state of the write destination RAIDG is not “during GC”, the processing proceeds to S163 (see FIG. 13).

(S152) The during GC writing unit 215 refers to the RAIDG management table 211c, and calculates a logical capacity offset in the access range from the position information (the LV start physical address CC6, the LV end physical address CC7) of the LV.

(S153) The during GC writing unit 215 refers to a bit value of the access management bit map 211d corresponding to the calculated logical capacity offset. It is to be noted that each bit value of the access management bit map 211d corresponds to data with the management size.

(S154) The during GC writing unit 215 determines based on the bit value referred to whether or not the data in the access range has been written to the save destination area. When the data has been written to the save destination area, the processing proceeds to S158. On the other hand, when the data has not been written to the save destination area, the processing proceeds to S155.

(S155) The during GC writing unit 215 determines whether or not the size of the access range is the management size. When the size of the access range is the management size, the processing proceeds to S158. On the other hand, when the size of the access range is not the management size, the processing proceeds to S156.

(S156) The during GC writing unit 215 reads data as a supplement to the management size from the write destination RAIDG, the supplement being the difference between the management size and the size of the access range. When data is read from the write destination RAIDG, the during GC writing unit 215 reads data from each SSD other than the SSDs in the “during GC” state. For instance, when the RAID level CC2 of a RAIDG is 5, the during GC writing unit 215 reads the parity data of each target SSD to reconstruct the data.

(S157) The during GC writing unit 215 merges the data (write data) requested to be written in the request for write access with the data read from the write destination RAIDG to generate data in the management size.

(S158) The during GC writing unit 215 refers to the RAIDG management table 211c, and calculates a logical capacity offset in the access range from the position information (the LV start physical address CC6, the LV end physical address CC7) of the LV. When the processing in S158 is completed, the processing proceeds to S159 (see FIG. 13).

(S159) The during GC writing unit 215 identifies the physical position of the save destination area from the save destination information table 211b, and the RAIDG management table 211c.

(S160) The during GC writing unit 215 writes data to the save destination area.

(S161) The during GC writing unit 215 determines whether or not the access management bit map 211d is in pre-update state. When the access management bit map 211d is in pre-update state, the processing proceeds to S162. On the other hand, when the access management bit map 211d is not in pre-update state, a series of processing illustrated in FIGS. 12 and 13 is completed.

(S162) The during GC writing unit 215 updates the bit value of the access management bit map 211d corresponding to the access range to a bit value indicating “data saved” (a state where data has been written to the save destination area). When the processing in S162 is completed, a series of processing illustrated in FIGS. 12 and 13 is completed.

(S163) The during GC writing unit 215 performs normal write processing. Specifically, the during GC writing unit 215 writes data to the access range specified in the request for write access. When the processing in S163 is completed, a series of processing illustrated in FIGS. 12 and 13 is completed.

[Read Access]

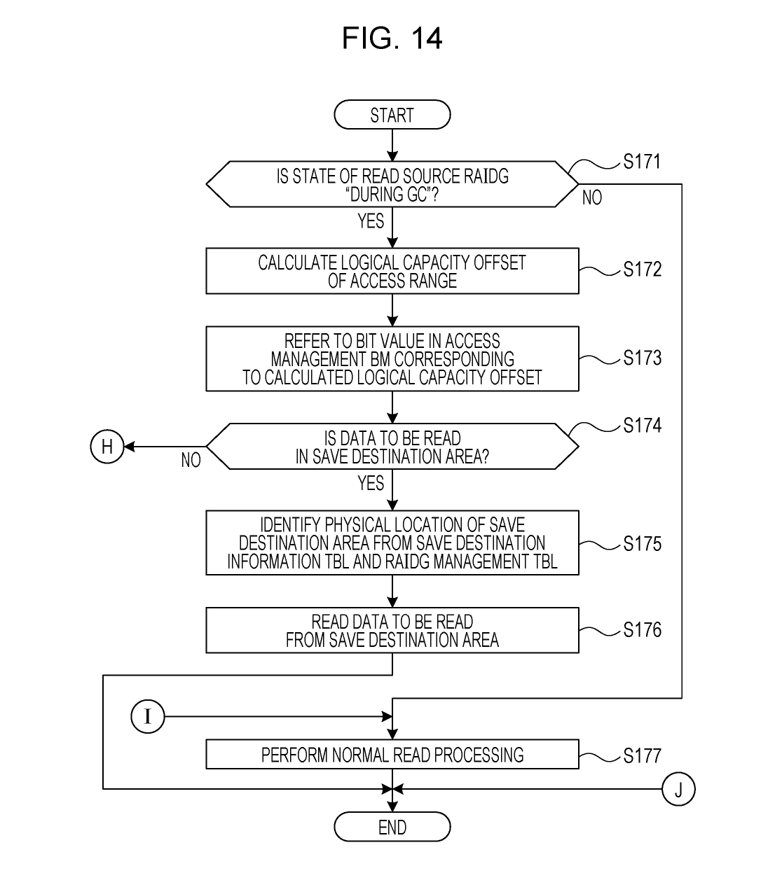

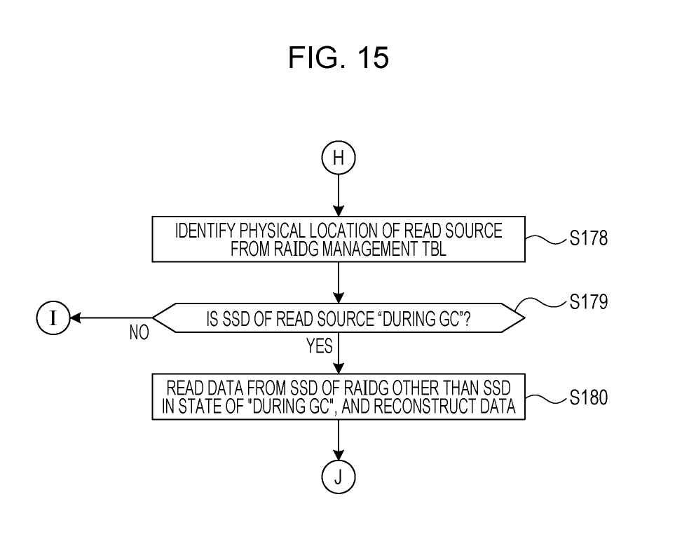

Next, the flow of processing according to a request for read access will be described with reference to FIGS. 14 and 15. FIG. 14 is a first flowchart illustrating the flow of processing according to a request for read access. FIG. 15 is a second flowchart illustrating the flow of processing according to a request for read access.

(S171) The during GC reading unit 217 refers to the GC target table 211a, and determines whether or not the state of the read source RAIDG corresponding to the read source (access range) specified in the request for read access is “during GC”. When the state of the read source RAIDG is “during GC”, the processing proceeds to S172. On the other hand, when the state of the read source RAIDG is not “during GC”, the processing proceeds to S177.

(S172) The during GC reading unit 217 refers to the RAIDG management table 211c, and calculates a logical capacity offset in the access range from the position information (the LV start physical address CC6, the LV end physical address CC7) of the LV.

(S173) The during GC reading unit 217 refers to a bit value of the access management bit map 211d corresponding to the calculated logical capacity offset. It is to be noted that each bit value of the access management bit map 211d corresponds to data with the management size.

(S174) The during GC reading unit 217 based on the bit value referred to whether or not the data (read data) in the access range is present in the save destination area. When the read data is present in the save destination area, the processing proceeds to S175. On the other hand, when the read data is not present in the save destination area, the processing proceeds to S178 (see FIG. 15).

(S175) The during GC reading unit 217 identifies the physical position of the save destination area corresponding to the access range from the save destination information table 211b and the RAIDG management table 211c.

(S176) The during GC reading unit 217 reads data from the save destination area, and returns response to the request for read access using the read data. When the processing in S176 is completed, a series of processing illustrated in FIGS. 14 and 15 is completed.

(S177) The during GC reading unit 217 performs normal read processing. Specifically, the during GC reading unit 217 reads data from the access range specified in the request for read access, and returns response to the request for read access using the read data. When the processing in S177 is completed, a series of processing illustrated in FIGS. 14 and 15 is completed.

(S178) The during GC reading unit 217 refers to the RAIDG management table 211c, and identifies the physical position of the access range which is the read source.

(S179) The during GC reading unit 217 determines whether or not the SSD at the read source is in the “during GC” state. When the SSD at the read source is in the “during GC” state, the processing proceeds to S180. On the other hand, when the SSD at the read source is not in the “during GC” state, the processing proceeds to S177 (see FIG. 14).

(S180) The during GC reading unit 217 reads data from each SSD of the RAIDG, other than the SSDs in the “during GC” state, and reconstruct the data. For instance, when the RAID level CC2 is 5, the during GC reading unit 217 reconstructs the read data using data such as parity data read from each SSD not in the “during GC” state. The during GC reading unit 217 then returns response to the request for read access using the reconstructed read data. When the processing in S180 is completed, a series of processing illustrated in FIGS. 14 and 15 is completed.

[Write Back]

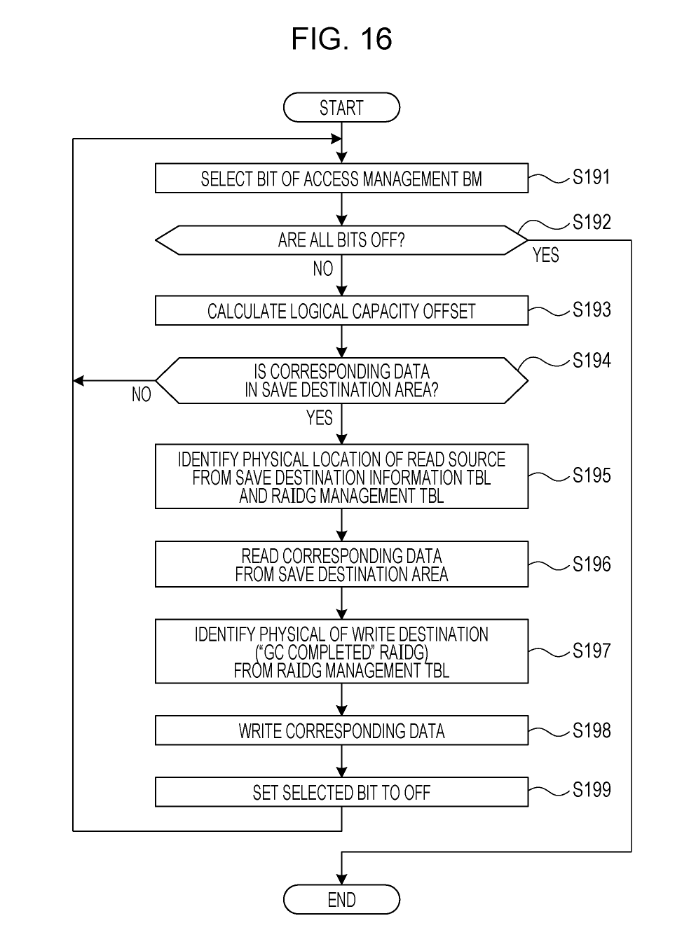

Next, the processing to write back will be described with reference to FIG. 16. FIG. 16 is a flowchart illustrating the flow of processing to write back.

(S191) The writing back unit 216 selects a bit of the access management bit map 211d.

(S192) The writing back unit 216 determines whether or not all the bits included in the access management bit map 211d are OFF.

It is to be noted that “a bit is OFF” indicates that data in the management size corresponding to the bit has been written back from a save destination area to a RAIDG in the “GC completed” state (a bit value indicating “data saved” state is set). When all the bits are OFF, a series of processing illustrated in FIG. 16 is completed. On the other hand, when at least one bit is not OFF (when there is a bit with a bit value indicating “data not saved” state), the processing proceeds to S193.

(S193) The writing back unit 216 refers to the access management bit map 211d, and calculates a logical capacity offset of the save destination area

(S194) The writing back unit 216 determines whether or not data (relevant data) to be written back is present in the save destination area. When the relevant data is present, the processing proceeds to S195. On the other hand, when no relevant data is present, the processing proceeds to S191.

(S195) The writing back unit 216 refers to the save destination information table 211b and the RAIDG management table 211c, and identifies the physical position of the read source from the position information (the start physical address of the save destination area, the end physical address of the save destination area) on the save destination area.

(S196) The writing back unit 216 reads the relevant data from the save destination area.

(S197) The writing back unit 216 refers to the RAIDG management table 211c, and identifies the physical position of a RAIDG (RAIDG in the “GC completed” state) which is a write destination of the relevant data.

(S198) The writing back unit 216 writes the relevant data to the identified physical position of the RAIDG. In other words, the writing back unit 216 writes the data (the relevant data) back to the original RAIDG, which has been saved to the save destination area from the RAIDG during GC.

(S199) The writing back unit 216 sets the selection bit to OFF. When the processing in S199 is completed, the processing proceeds to S191.

As described above, write access is prohibited RAIDG by RAIDG during GC, and data is saved in the save destination area, thereby making it possible to reduce risk of having write access to an SSD in which it is probable that spare blocks are exhausted. The risk of delay in response is reduced by controlling GC with this method. The second embodiment has been described above.

Although a description is given above using SSD as an example for the sake of description, the above-described technique according to the second embodiment is applicable to a recording medium using a memory having rewrite characteristics (the property that overwriting is not possible) similar to those of a NAND flash memory.

Meanwhile, the above-described function of the storage control apparatus 121 is implemented by the processor 121a by operating in accordance with the program stored in the memory 121b. The program may be recorded on a computer-readable recording medium. The recording medium includes a magnetic storage device, an optical disc, and semiconductor memory. The magnetic storage device includes a hard disk drive (HDD), a flexible disk (FD), and magnetic tape. The optical disc includes a CD-ROM, a CD-R/RW, and a Blu-ray (registered trademark). A magneto-optical medium includes an MO.

Also, when the program is distributed, for instance, a portable recording medium, such as a CD-ROM, on which the program is recorded is sold. Also, the program may be stored in a memory device of a server computer, and may be transferred from the server computer to another computer via a network. The storage control apparatus 121 may obtain the program from the recording medium, the server computer as described above, or another computer, and may store the program in the memory 121b.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A storage control apparatus that controls a plurality of storage devices, each of which includes a plurality of storage groups, the storage control apparatus comprising:
a memory; and
a processor coupled to the memory and the processor configured to:
detect a first storage device from the plurality of storage devices, the first storage device having an area on which garbage collection is to be executed;
identify a first storage group from the plurality of storage groups, the first storage group including the first storage device;
prohibit write access to the plurality of storage devices included in the identified first storage group; and
instruct the first storage device to execute the garbage collection.

2. The storage control apparatus according to claim 1,
wherein the processor is configured to secure a save destination for data, from a memory area in a second storage group different from the first storage group, the data being at a destination of write access to the first storage group requested during execution of the garbage collection.

3. The storage control apparatus according to claim 2,
wherein upon receiving a request for read access to the first storage device during execution of the garbage collection, when data to be read by the read access is in a memory area at the save destination, the processor is configured to return response to the request using the data read from the memory area at the save destination.

4. The storage control apparatus according to claim 3,
wherein upon receiving a request for read access to the first storage device during execution of the garbage collection, when data to be read by the read access is not in the memory area at the save destination, the processor is configured to return response to the request using redundant data read from at least one second storage device included in the first storage group.

5. The storage control apparatus according to claim 2,
wherein after the garbage collection is completed, the processor is configured to write data in the memory area at the save destination back to a memory area at a destination of the write access in the first storage group.

6. The storage control apparatus according to claim 2,
wherein after the garbage collection is completed for a plurality of first storage devices, each of which is the first storage device, having all target areas on which the garbage collection is executed in the first storage group, the processor is configured to write data in the memory area at the save destination back to a memory area at a destination of the write access in the first storage group.

7. A computer-readable non-transitory recording medium storing a program that causes a computer to execute a procedure, the computer controlling a plurality of storage devices, each of which includes a plurality of storage groups, the procedure comprising:
detecting a first storage device from the plurality of storage devices, the first storage device having an area on which garbage collection is to be executed;
identifying a first storage group from the plurality of storage groups, the first storage group including the first storage device;
prohibiting write access to the plurality of storage devices included in the identified first storage group; and
instructing the first storage device to execute the garbage collection.

8. The computer-readable non-transitory recording medium according to claim 7,
wherein the procedure secures a save destination for data, from a memory area in a second storage group different from the first storage group, the data being at a destination of write access to the first storage group requested during execution of the garbage collection.

9. The computer-readable non-transitory recording medium according to claim 8,
wherein upon receiving a request for read access to the first storage device during execution of the garbage collection, when data to be read by the read access is in a memory area at the save destination, the procedure returns response to the request using the data read from the memory area at the save destination.

10. The computer-readable non-transitory recording medium according to claim 9,
wherein upon receiving a request for read access to the first storage device during execution of the garbage collection, when data to be read by the read access is not in the memory area at the save destination, the procedure returns response to the request using redundant data read from at least one second storage device included in the first storage group.

11. The computer-readable non-transitory recording medium according to claim 8,
wherein after the garbage collection is completed, the procedure writes data in the memory area at the save destination back to a memory area at a destination of the write access in the first storage group.

12. A method of controlling garbage collection comprising:
selecting a storage device from a plurality of storage devices, the plurality of storage devices being separated into a plurality of groups;
acquiring a proportion of spare blocks;
comparing the proportion of spare blocks with a predetermined value;
identifying one of the plurality of groups that includes the storage device when the proportion of spare blocks is smaller than the predetermined value;
prohibiting write access to storage devices included in the one of the plurality of groups; and
executing, by the storage device, garbage collection.

13. The method of claim 12, further comprising:
issuing a state acquisition instruction to the storage device.

14. The method of claim 12, further comprising:
determining that each storage device in the plurality of groups has been selected.

15. The method of claim 12, further comprising:
determining whether the one of the plurality of groups is registered in a garbage collection target table.

16. The method of claim 15, further comprising:
registering the one of the plurality of groups when a determination is made that the one of the plurality of groups is not registered in the garbage collection target table.

17. The method of claim 15, further comprising:
registering the storage device in the garbage collection target table when a determination is made that the one of the plurality of groups is registered in the garbage collection target table.
